(19) United States
(12) Patent Application Publication
(10) Pub. No.: US 2018/0353834 A1
(43) Pub. Date: Dec. 13, 2018

(54) WEIGHT RACK WITH IN-PLANE IDENTIFICATION MARKINGS

(71) Applicant: TAG Fitness, Mundelein, IL (US)

(72) Inventors: Tim GREEN, Mundelein, IL (US); Scott CADA, Mundelein, IL (US)

(21) Appl. No.: 16/005,009

(22) Filed: Jun. 11, 2018

Related U.S. Application Data
(60) Provisional application No. 62/517,231, filed on Jun. 9, 2017.

(51) Int. Cl. A63B 71/00

(52) U.S. Cl. CPC A63B 71/0036; B23K 26/384

(57) ABSTRACT

This disclosure pertains to a storage rack for weights, or “weight rack” or “dumbbell rack” as commonly referred to in the exercise equipment industry, which includes in-plane identification markings, such as numbering, designating both the location and amount of a particular weight supported by the rack. The in-plane identification markings are formed in at least one user reference surface to designate the weight of the dumbbell to be supported in that specific location of the rack. The in-plane identification markings are formed in at least one of the horizontal support members proximate to the saddles that receive the dumbbells. The in-plane identification markings are extremely durable and provide guidance for users of the weights as to precisely where to return the weights after use. Returning the weights to their proper location on the weight rack improves usage of the racks and reduces clean-up efforts by employees.

### PRIORITY CLAIM

This application claims priority from U.S. Provisional Patent Application No. 62/517,231, filed Jun. 9, 2017, which is incorporated herein by reference and made a part hereof.

### TECHNICAL FIELD

This disclosure relates to a weight or dumbbell rack with in-plane identification markings, such as numbering, formed in at least one user reference surface to designate the weight of the dumbbell to be supported in that specific location of the rack.

### BACKGROUND

Conventional weight racks found in gyms or workout facilities usually have labels, typically adhesive stickers, which are affixed to a portion of the racks that identify the amount of weight supported in a specific location of the rack. For example, 55 pound dumbbells may be located on the left side of the weight rack, while 75 pound dumbbells may be located on the right of the rack and intermediate dumbbells are located there between. Conventional racks include a “55” sticker to label the specific location of the rack where the 55 pound dumbbells are supposed to reside and a “75” sticker to label the specific location of the rack where the 75 pound dumbbells are supposed to reside.

The labels are usually affixed to an area of the rack that is susceptible to high-wear, such as between the saddles that receive the heads of the dumbbells which is where a user places their hands to grasp the bar that connects the dumbbell heads prior to removing the dumbbell from the rack. These locations, including the labels, are prone to being contacted by the dumbbell heads or the user's hands scraping, which causes the labels to wear. As this wear continues over time, the labels become less legible and the numbering on the label becomes illegible. With further wear and tea, the labels eventually fall-off the dumbbell racks. When the legibility of the labels is reduced or the labels fall-off the rack, users do not know where the dumbbells should be placed, which leads to the dumbbells being returned to improper locations on the rack. In turn, this complicates further usage of the dumbbells by other users because the desired dumbbell with a specific weight rating is not found in its proper location on the rack. For example, when 25 pound dumbbells are placed in the specified location on the rack for 45 pound dumbbells, the user has to spend to valuable time looking or “hunting” for the displaced 45 pound dumbbells. This situation is exacerbated in large gyms and workout facilities which have numerous dumbbell racks that can be aligned end-to-end, causing the user to have to walk the combined length of the racks hunting for the displaced dumbbells the user is seeking. Also, when the dumbbells are not placed in their proper locations on the rack, employees of the gym or workout facility have to spend valuable time reorganizing the dumbbells to ensure their proper positioning on the rack to facilitate future use by other gym members.

Accordingly, there is an unmet need for a weight rack having durable, in-plane identification markings, such as numbers, that are not susceptible to wearing out over time and then falling off due to typical usage of the dumbbells. The in-plane identification markings improve the user' interaction with and usage of the racks, while reducing clean-up efforts and costs by employees of the gym or workout facility.

### SUMMARY OF THE INVENTION

This disclosure provides a weight or dumbbell rack with in-plane identification markings, such as numbering, formed in at least one user reference surface to designate the weight of the dumbbell to be supported in that specific location of the rack. In some embodiments of the present disclosure, the weight rack includes at least one support member having a plurality of saddles that each receive a dumbbell. The weight rack includes identification markings that are formed in-plane in the support member wherein the support member functions as a reference surface for the user to locate the dumbbell weight he/she desires to use. These in-plane markings can be formed, preferably laser cut, in the support member to provide durable, high-contrast labeling that is not prone to wear and thus does not fall-off the weight rack after prolonged use.

The in-plane identification marking is positioned proximate a saddle and comprises a number corresponding to the weight of the dumbbell supported by the saddle. In this manner, the weight rack includes at least one user reference surface having a plurality of in-plane markings that identify the location and weight of the dumbbells in the specific areas of the rack. The identification of the dumbbell's location and weight enables the user to efficiently locate and remove his/her desired dumbbell for the exercise to be performed, and then to return the dumbbell to its proper location on the rack, which facilitate subsequent another user.

Other features and advantages of the disclosure will be apparent from the following specification taken in conjunction with the following drawings.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a top perspective view of a weight rack according to exemplary embodiments of the present disclosure.

FIG. 2 is a side view of the weight rack shown in FIG. 1.

FIG. 3 is a front view of the weight rack shown in FIG. 1.

FIG. 4 is a top view of the weight rack shown in FIG. 1.

FIG. 5 is a cross-section view of the weight rack taken along line 5-5 of FIG. 1.

### DETAILED DESCRIPTION

While this disclosure includes a number of details and embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated.

This disclosure pertains to an improved storage rack for weights, or “weight rack” or “dumbbell rack” as commonly referred to in the exercise equipment industry, which includes in-plane identification markings, such as numbering, designating the amount and the location of a particular weight supported by the weight rack. The weight rack at least one support member with identification markings formed in-plane in the support member, wherein the support member functions as a reference surface for the user to locate the dumbbell weight he/she desires to use. The support member is also configured to engage and support at least one dumbbell D, preferably a collection of dumbbells D having different set weight amounts.

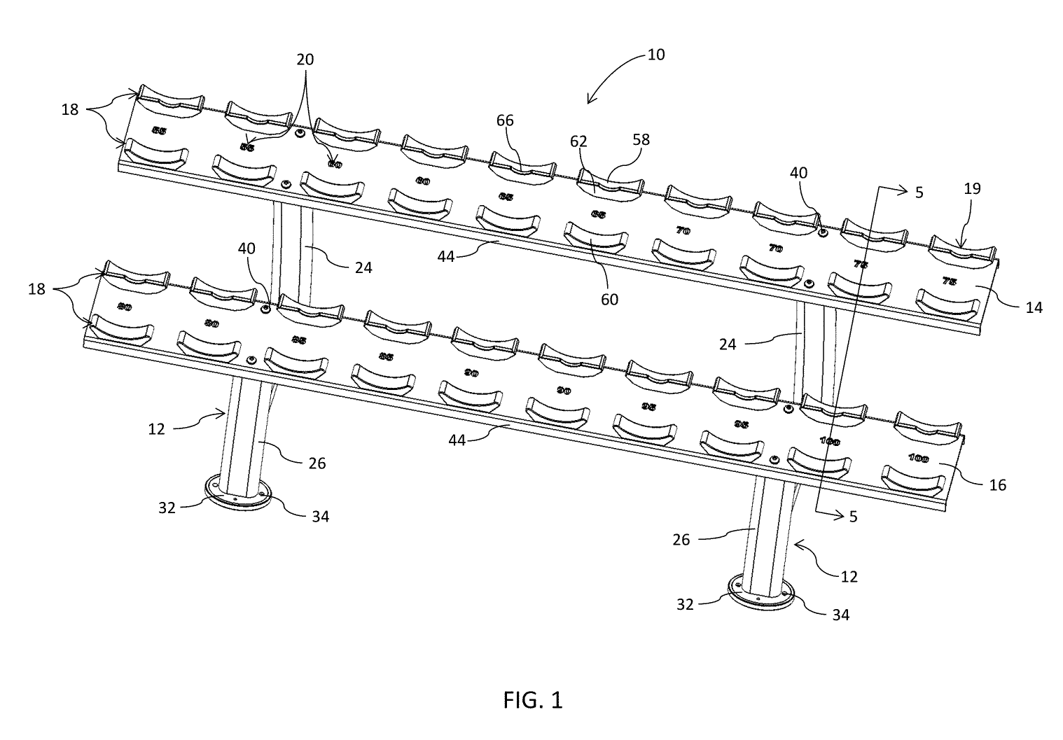

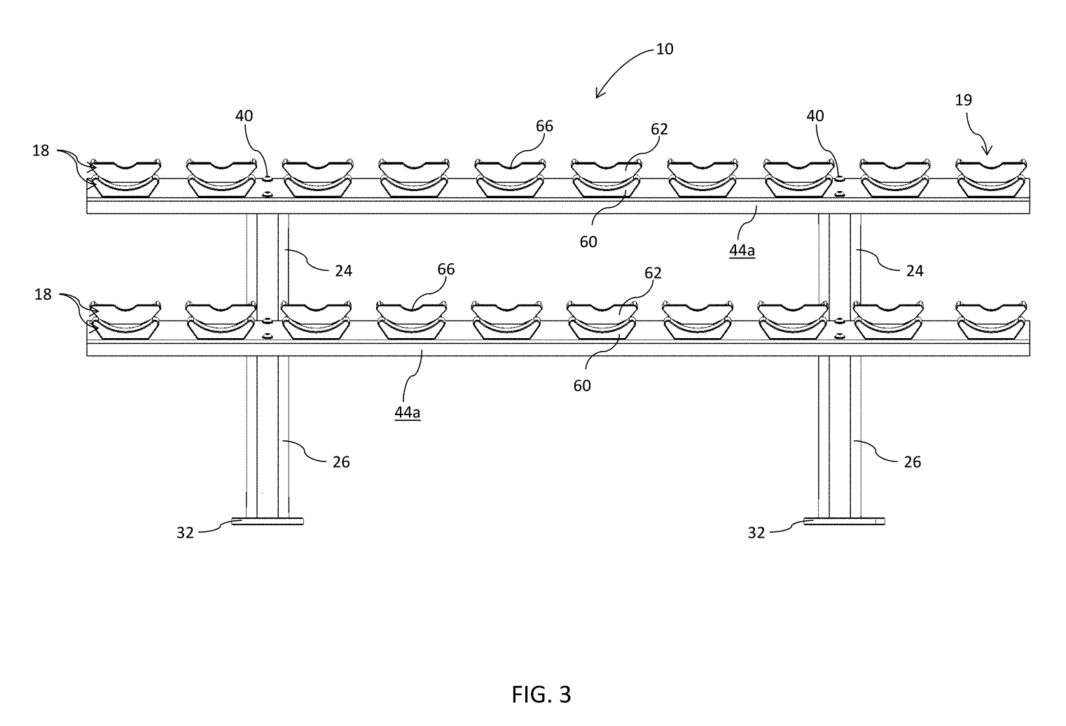

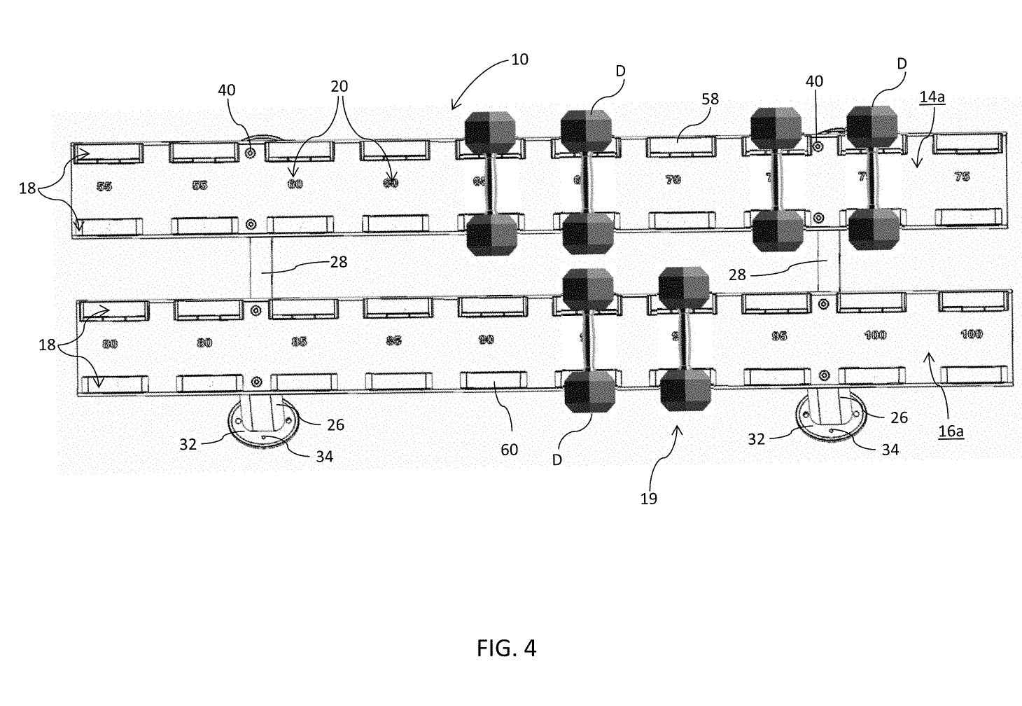

In the embodiment shown in FIGS. 1-5, the rack is configured as a dumbbell rack 10 with in-plane identification markings 20 that are formed in at least one of the substantially horizontal support members 14, 16 to provide the user reference surface that the user can read and quickly determine the weight of the dumbbell D in that region of the rack 10 and/or the weight of the nearby dumbbells D. The user reference surface also allows the user to promptly determine where he/she should return or “rack” a dumbbell D after the user is done using it. As discussed below, the orderly return and organization of dumbbells D on the rack 10 provides a number of benefits. The markings 20 are formed in the support member 14, 16 proximate to a pair of saddles 18 that are affixed to the support members 14, 16. The saddles 18 define a receiver 19 that receives or engages opposed heads of the dumbbell D in a non-use position (see FIG. 4) where the dumbbells D are ready to be accessed by a user to perform an exercise (e.g., dumbbell chest press, dumbbell bicep curls). The in-plane identification markings 20 are extremely durable and provide guidance for users of the weights or dumbbells as to precisely where to return the weights or dumbbells after use, which directly benefits subsequent users who are looking for a specific dumbbell weight.

The weight rack 10 also includes vertical support leg arrangements 12 to elevate and position the support members 14, 16 in a manner that makes utilizing the weights or dumbbells easier and more efficient. In the illustrated embodiment, each vertical support leg arrangement 12 includes a first leg 24, a second leg 26, a cross-member 28, a first foot 30, a second foot 32, first transverse support 36, and second transverse support 38. The first leg 24 is substantially longer than the second leg 26. The first leg 24 is shown as being approximately 32 inches, while the second leg 26 is shown as being approximately 17 inches. It should be understood that other lengths may be used, including having both the first leg 24 and second leg 26 with similar lengths. The difference in height between the first leg 24 and the second leg 26 allows the upper support member 14 to be placed at a different height than the lower support member 16, which creates a two tier design that allows the user to have easier access to the dumbbells D. The arrangement of legs 24, 26 has a curvilinear configuration and is designed to elevate the dumbbells D above the support surface that the weight rack 10 rest upon. However, it should be understood that other designs, such as straight legs could be used in the vertical support leg arrangement 12. Further, the legs 24, 26 have a substantially oval shaped cross-section and are made from metal, such as steel. It should be understood that other materials and shapes, such as square, rectangular may be used to form the rack 10.

The first leg 24 and second leg 26 are coupled to at least one cross-member 28. The coupling of the cross-member 28 to the legs 24, 26 is preferably by welding; however, bolts, rivets, or other similar coupling methods may be used. In the illustrated embodiment, the length of the cross-member is approximately 22 inches; however, other lengths that provide sufficient stability to the weight rack 10 may also be used. The cross-member 28 is substantially oval shaped to match the legs 24, 26 and made from metal, such as steel. The first leg 24 is coupled to the first foot 30 and the second leg 26 is coupled to the second foot 32. The coupling of the feet 30, 32 to the legs 24, 26 is preferably by welding; however, bolts, rivets, or other similar coupling methods may be used. The feet 30, 32 are configured to have an area that is larger than the cross-sectional area of the associated legs 24, 26, which provides additional stability to the rack 10. The feet 30, 32 also have at least one hole 34 to allow the rack 10 to be secured to the floor of the gym or workout facility. Although not shown in the figures, the feet 30, 32 may have an exterior rubber covering to minimize any damage to the floor.

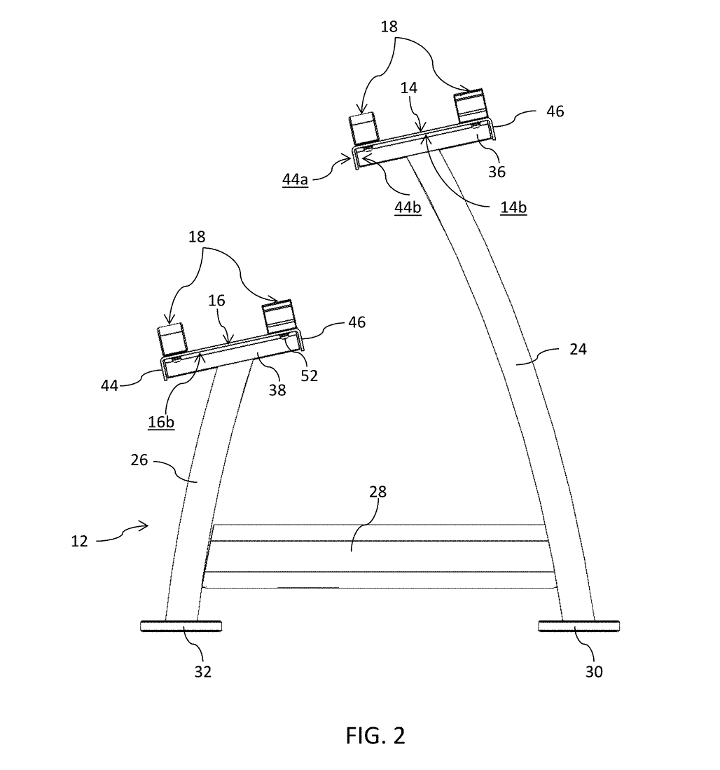

Referring to FIG. 2, the first leg 24 is coupled to the upper support member 14 via the first transverse member 36. The second leg 26 is coupled to lower support member 16 via the second transverse member 38. The coupling of the transverse members 36, 38 to the legs 24, 26 is preferably by welding; however, bolts, rivets, or other similar coupling methods may be used. The transverse members 36, 38 are preferably located near the end segments of the support members 14, 16 and thus further support these members when dumbbells are loaded onto the weight rack 10. In the illustrated embodiment, the transverse members 36, 38 are positioned within the U-shape of the support members 14, 16. The length of the transverse members 36, 38 is approximately 8.4 inches, wherein the transverse supports 36, 38 extend between the front and rear flanges 44, 46 of the support members 14, 16. The coupling of the transverse members 36, 38 to the respective support members 14, 16 is preferably done by bolts 40; however, welding, rivets, or other similar coupling methods may be used.

The vertical support leg arrangement 12 can be configured in alternative manners without departing from the scope of the invention. For example, the vertical support leg arrangement 12 can include only a first leg 24 and an elongated foot 30, wherein the elongated foot 30 is long enough to provide stability to the first leg 24. In this embodiment, the first leg 24 is coupled to both the upper support member 14 and the lower support member 16. The first leg 24 is angled in such a manner that it provides the user with access to dumbbells stored on both the support members 14, 16. In the embodiment of FIGS. 1-5, the support members 14, 16 are approximately 90 inches long, which provides enough space for about 10 individual dumbbells or 5 pairs of dumbbells to be placed on each support member 14, 16. It should be understood that the rack 10 can be configured with support members 14, 16 having different lengths if a lesser or greater number of dumbbells are desired. For example, the length of the support members 14, 16 may be reduced to approximately 53 inches, if it is desired to place only 6 individual dumbbells or 3 pairs of dumbbells on each horizontal weight support member.

As mentioned above, the support members 14, 16 have front and rear flanges 44, 46 and an intermediate portion 64 extending between the flanges 44, 45. The intermediate portion 64 is substantially planar which provides the support members 14, 16 with a substantially U-shaped cross-section. The combination of the intermediate portion 64 and the flanges 44, 45 reduces the likelihood that the user will scrape their hands when accessing dumbbells because there is no raised rail near the saddles 18 that receive dumbbells. In the illustrated embodiment, the intermediate portion 64 has a width of approximately 8.5 inches between the flanges 44, 45, and the flanges 44, 45 depend downward approximately 1.2 inches. The support members 14, 16 are oriented at angle to horizontal to make it easier for a user to access the dumbbells to remove them from and/or return them to the saddles 18. In the illustrated embodiment, both of the support members 14, 16 are approximately angled 10-15 degrees to horizontal.

A plurality of saddles 18 are distributed across the length of the support members 14, 16, wherein the saddles are affixed to an upper surface of the members 14, 16. Each saddle 18 comprises a first component 58 and a second component 60 that are preferably arcuate. The first and second components 58, 60 collectively define the receiver 19 that engage a dumbbell D. The first component 58 can have a lip 62 for retaining the dumbbell D in a fixed position after the user returns the dumbbell to the rack 10. By placing the lip 62 only on the first component 58, there is a reduced chance that the user will scrape their hands accessing and/or returning the dumbbells because the second component 60 lacks the lip 62. Referring to FIG. 1, the lip 62 includes a recess 66 configured to receive an extent of the bar that extends between the heads of the dumbbell. The saddles 18 are coupled to the support members 14, 16 by bolts 50 that extend upward through the support members 14, 16. Thus, the head 52 of the bolts 50 are positioned on the underside of the support members 14, 16 and extend through holes 54 in the support members 14, 16 to couple with a nut 56 that is imbedded in the saddles 18. This placement of the bolts 50 increases durability of the saddles because there are no holes extending completely through the saddles 18. In addition, it provides a smooth and finished appearance for the saddles 18.

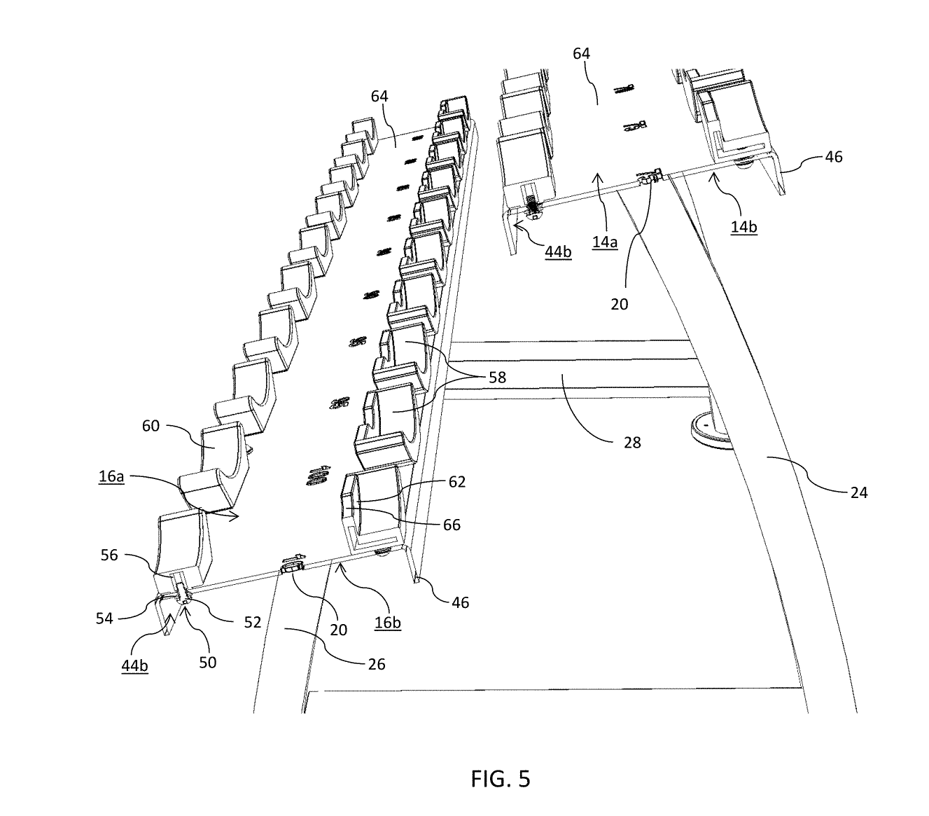

Referring to FIGS. 1, 4 and 5, the rack 10 includes the in-plane identification markings 20 that have been formed in an extent of the support members 14, 16. Focusing specifically on FIG. 5, the in-plane identification markings 20 are located in the intermediate portion 64 of the support members 14, 16 between the components 58, 60 of the saddles 18. The markings 20 are considered “in-plane” in that they are formed within the intermediate portion 64 and reside within the plane that defines the intermediate portion 64. Preferably, the in-plane markings 20 do not extend above or beyond the plane that defines the intermediate portion 64. Also, the in-plane markings 20 do not extend above or beyond an upper surface 14a, 16a of the support member 14, 16. Alternatively, the markings 20 are formed in-plane in a front flange 44 of the support members 14, 16. The front flange 44 includes a front surface 44a and an opposed rear surface 44b, the rear surface 44b being oriented towards the intermediate portion 64 of the support member 14, 16 and the rear flange 46. The in-plane identification markings 20 do not extend beyond the front surface 44a of the front flange 44.

The in-plane identification markings 20 are configured as numbers designating the amount of dumbbell weight supported by a specific saddle 18 in a specific location of the rack 10. For example, the number “55” is formed in the left region of the upper support member 14 which indicates that the 55 lb. dumbbells should be stored in that location, while the number “75” is formed in the right region of the upper support member 14 which indicates that the 75 lb. dumbbells should be stored in that location. In addition to the in-plane identification markings 20 numerically designating the amount of dumbbell weight, the support member 14, 16 can also include a second arrangement of in-plane identification markings 20. This secondary arrangement of markings 20 can be configured as the shape or color of the weight may be used. Alternatively, this secondary arrangement of markings 20 is configured as the name, logo, symbol or trademark of the manufacturer of the rack 10. Other secondary in-plane identification markings 20 can include the name, logo, symbol or trademark of the gym or training facility where the rack 10 is located. In this manner, the rack 10 includes in-plane identification markings 20 that specify the weight amounts of the various dumbbells D while reinforcing the brand awareness of the manufacturer of the rack 10, or the gym or training facility where the rack 10 is located for use.

The in-plane identification markings 20 are formed by removing material from the support members 14, 16 with the use of a laser; however it should be understood that other methods, such as water jets, CNC machines, or a plasma cutters may be used to remove material from the support members 14, 16 to form the in-plane identification markings 20. In the embodiment of the Figures, the in-plane identification markings 20 are formed by removing material from the support members 14, 16 to define markings 20 that are “through holes” formed entirely through the support members 14, 16. A backing element (not shown) can be affixed to the lower surface 14b, 16b of the support member 14, 16 and aligned with the in-plane markings 20. This backing element can fabricated from a material having a different color than the support member 14, 16 to provide a contrasting appearance that increases visibility of the in-plane identification markings 20.

In an alternate embodiment (not shown), the in-plane identification markings 20 are formed by removing an extent of material from the support members 14, 16 to define markings 20 that are not through holes, meaning that the markings 20 are not formed entirely through the support members 14, 16. In this embodiment, the markings 20 can comprise a recess or channel that is recessed from the upper surface 14a, 16a of the support members 14, 16, but that does not extend to the lower surface 14b, 16b of the support members 14, 16. The recessed channel can be filled with a second material of a different color than the support members 14, 16 to provide a contrasting appearance that increases visibility of the in-plane identification markings 20. For example, the support member 14, 16 can have a first color—such as a gray, silver or black—while the recessed channel of the markings 20 is filled with a second color—such as a bright yellow, green or orange—to provide a high contrast, high visibility appearance to the in-plane identification markings 20.

By forming the in-plane identification markings 20 in the support members 14, 16, the in-plane identification markings 20 are both highly-visible and extremely durable and thus not susceptible to wearing-off over time, like conventional labels or stickers. The highly-visible and extremely durable markings 20 improve usage of the racks and reduce clean-up time by employees of the gym or workout facility. In addition, forming the in-plane identification markings 20 in the support members 14, 16 provides high-contrast between the support members 14, 16 and the in-plane identification markings 20, which makes the markings 20 easy to read by various users who want to use different dumbbells supported by the rack 10.

### INDUSTRIAL APPLICABILITY

The above disclosure relates to a weight or dumbbell rack with in-plane identification markings, such as numbering, formed in at least one user reference surface to designate the weight of the dumbbell to be supported in that specific location of the rack.

While some implementations have been illustrated and described, numerous modifications come to mind without significantly departing from the spirit of the disclosure; and the scope of protection is only limited by the scope of the accompanying claims. For example, in-plane identification markings 20 may be formed into other gym equipment, such as vertical dumbbell racks, power racks, plate trees, kettlebell racks, etc. without departing from the scope of this invention. In such embodiments, the in-plane identification markings 20 may be formed in a location for the user to easily view the in-plane identification markings 20 and thus readily understand what weights, including amounts, are to be placed in that location.

Headings and subheadings, if any, are used for convenience only and are not limiting. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

What is claimed is:

1. A weight rack with in-plane identification markings to specify the location and weight rating of dumbbells supported by the weight rack, the weigh rack comprising:
at least one horizontal support member, said support member having a plurality of saddles affixed to an upper surface of said support member, wherein each saddle is configured to removably receive a dumbbell;
an arrangement of legs coupled to the support member to secure it in an elevated position above a support surface upon which the weight rack is placed;
wherein the support member has a series of in-plane identification markings formed within the support member, and wherein said identification markings are associated with a specific saddle to indicate the location and amount of dumbbell weight to be received by that specific saddle.

2. The weight rack of claim 1, wherein the in-plane identification markings are formed by using a laser to remove material from the horizontal support member.

3. The weight rack of claim 1, wherein the in-plane identification markings are numbers that identify the amount of dumbbell weight.

4. The weight rack of claim 1, wherein the in-plane identification markings do not extend beyond an upper surface of the support member.

5. The weight rack of claim 1, wherein each saddle includes a first component and a second component affixed to an upper surface of the support member.

6. The weight rack of claim 5, wherein the in-plane identification marking is formed in an intermediate portion of the support member and substantially between the first component and the second component.

7. The weight rack of claim 5, wherein a single in-plane identification marking is positioned substantially between a pair of saddles to indicate the location and amount of a pair of dumbbells having the same weight to be received by that pair of saddles.

8. The weight rack of claim 1, wherein the support member has a front flange depending from a periphery of the support member, and wherein the in-plane identification markings are formed in the front flange.

9. The weight rack of claim 8, wherein the front flange includes a front surface and an opposed rear surface, the rear surface being oriented towards an intermediate portion of the support member, and wherein the in-plane identification markings do not extend beyond the front surface of the front flange.

10. A weight rack with an in-plane identification marking system to identify the weight ratings of dumbbells, the weigh rack comprising:
at least one horizontal support member, said support member having a plurality of saddles affixed to an upper surface of said support member, wherein each saddle is configured to receive a dumbbell in a non-use position;
an arrangement of legs coupled to the support member to secure it in a substantially horizontal position;
wherein the support member has a series of in-plane identification markings formed in the support member, wherein the in-plane identification markings do not extend above an upper surface of the support member, and
wherein said identification markings are associated with a specific saddle to indicate the location and weight rating of a dumbbell to be received by that specific saddle.

11. The weight rack of claim 10, wherein the in-plane identification markings are formed entirely through the support member.

12. The weight rack of claim 10, wherein the in-plane identification markings are formed by using a laser to remove material from the horizontal support member.

13. The weight rack of claim 10, wherein the in-plane identification markings are numbers that identify an amount of dumbbell weight.

14. The weight rack of claim 10, wherein each saddle includes a first component and a second component affixed to an upper surface of the support member, wherein the first and second components collectively define a receiver that removably engages a dumbbell.

15. The weight rack of claim 14, wherein the in-plane identification marking is formed in an intermediate portion of the support member and substantially between the first component and the second component of the saddle.

16. The weight rack of claim 14, wherein a single in-plane identification marking is positioned substantially between a pair of saddles to indicate the location and amount of a pair of dumbbells having the same weight to be received by that pair of saddles.

17. The weight rack of claim 10, wherein the support member includes a secondary arrangement of in-plane identification markings designating a manufacturer of the weight rack or a training facility where the weight rack is located.
